(19) United States
(12) Patent Application Publication
(10) Pub. No.: US 2009/0160156 A1
(43) Pub. Date: Jun. 25, 2009

(54) UPPER FRAME OF FRONT FORK FOR BICYCLE

(75) Inventor: Kuo-Pin YU, Taichung (TW)

Correspondence Address: BROWDY AND NEIMARK, P.L.L.C.;624 NINTH STREET, NW, SUITE 300, WASHINGTON, DC, 20001-5303, US

(73) Assignee: YUAN MIN AN ENTERPRISE CO., LTD., Taichung (TW)

(21) Appl. No.: 12/107,367

(22) Filed: Apr. 22, 2008

(30) Foreign Application Priority Data
Dec. 25, 2007 (TW) 96222104

(51) Int. Cl. B62K 25/08

(52) U.S. Cl. 280/276

(57) ABSTRACT

An upper frame of a front fork for a bicycle includes an upright tube and two branch tubes. The upright tube has an axial rib. The two branch tubes extend bilaterally from a bottom end of the upright tube and each have an axial rib parallel substantially to a longitudinal direction of the upright tube and a connecting portion located at an end of the branch tube for connection of a fork tube. Thus, the structure strength of the upright tube can be enhanced by the axial rib thereof, and the structure strength of the branch tubes can be enhanced by the axial ribs thereof to bear stress generated from the fork tubes.

### BACKGROUND OF THE INVENTION

1. Field of the Invention

The present invention relates generally to a bicycle, and more specifically to an upper frame of a front fork for a bicycle, which has improved structure strength to bear stress generated from a front wheel of the bicycle.

2. Description of the Related Art

A conventional front fork of a bicycle, which is made of carbon fiber reinforced resin, includes an upright tube, a fork crown integrally mounted on a bottom end of the upright tube, and two fork tubes respectively extending downwardly from two ends of the fork crown.

In actual use, the upright tube may be easily damaged due to stress parallel to forward and backward directions of the bicycle. The fork crown may be damaged due to an axial stress generated by the fork tubes. Thus, the issue of how to improve the structure strength of the front fork of the bicycle, especially for a mountain bicycle, is always the manufacture's concern.

### SUMMARY OF THE INVENTION

The present invention has been accomplished in view of the above-noted circumstances. It is one objective of the present invention to provide an upper frame of a front fork for a bicycle, which has improved structure strength to bear stress generated from a front wheel of the bicycle.

To achieve this objective of the present invention, the upper frame of the front fork for the bicycle comprises an upright tube and two branch tubes. The upright tube has an axial rib. The branch tubes extend bilaterally from a bottom end of the upright tube and each have an axial rib parallel substantially to a longitudinal direction of the upright tube and a connecting portion located at an end of the branch tube for connection of a fork tube.

Accordingly, the upright tube can enhance its structure strength by the axial rib thereof, and the branch tubes also can enhance their structure strength by the axial ribs thereof to bear stress generated from the fork tubes.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a front view of the upper frame according to a preferred embodiment of the present invention;

FIG. 2 is a cutaway view of the upper frame according to the preferred embodiment of the present invention;

FIG. 3 is a top view of the upper frame according to the preferred embodiment of the present invention, and

FIG. 4 is a top cutaway view of the branch tubes of the upper frame according to the preferred embodiment of the present invention.

### DETAILED DESCRIPTION OF THE INVENTION

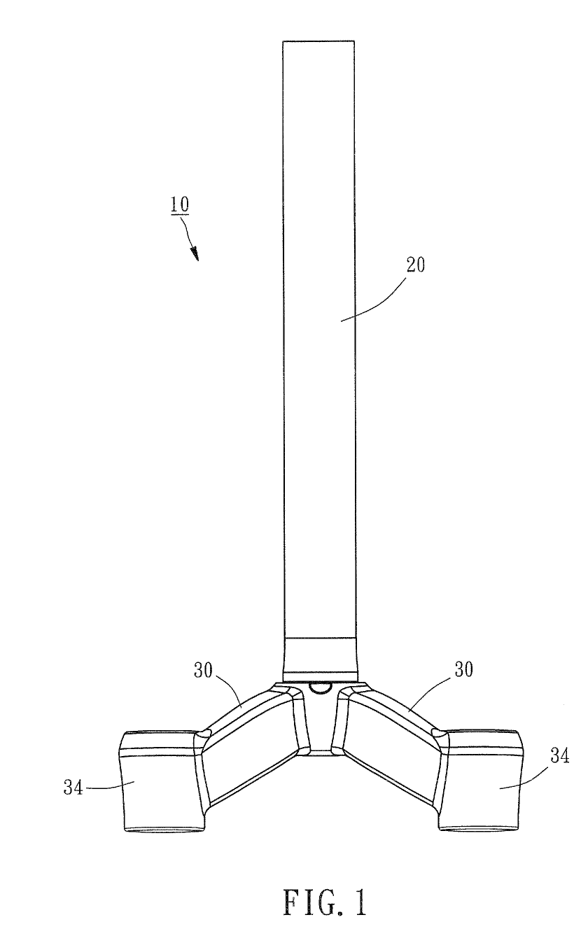

As shown in FIGS. 1 to 4, an upper frame 10 of a front fork for a bicycle in accordance with the preferred embodiment of the present invention is integrally made of carbon fiber reinforced resin. The upper frame 10 comprises an upright tube 20 and two branch tubes 30. The fiber may adopt, but not limited to, carbon fiber, glass fiber, boron fiber or Kevlar fiber. The resin may adopt, but not limited to, thermosetting resin or thermoplastic resin.

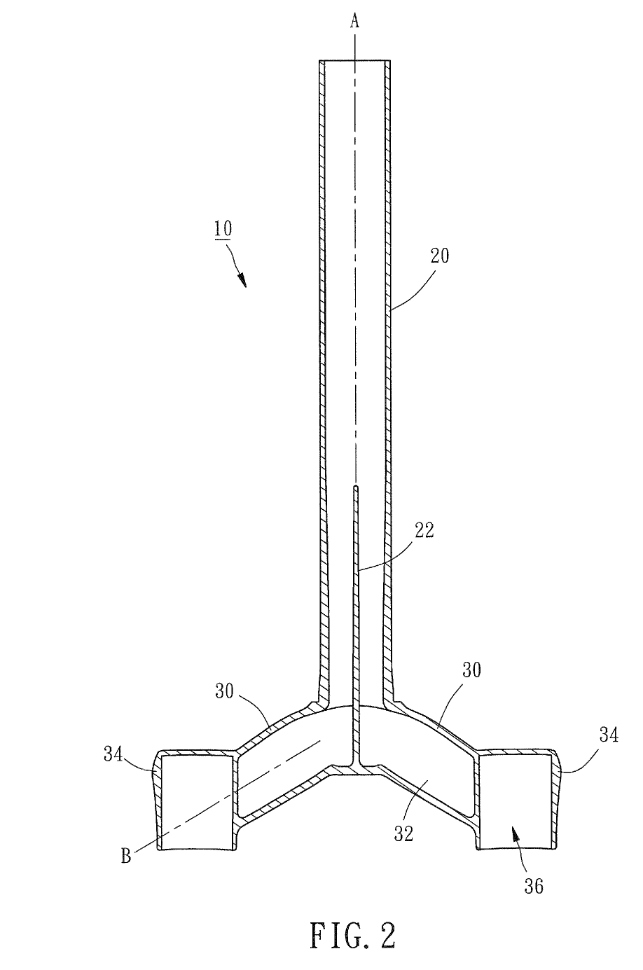

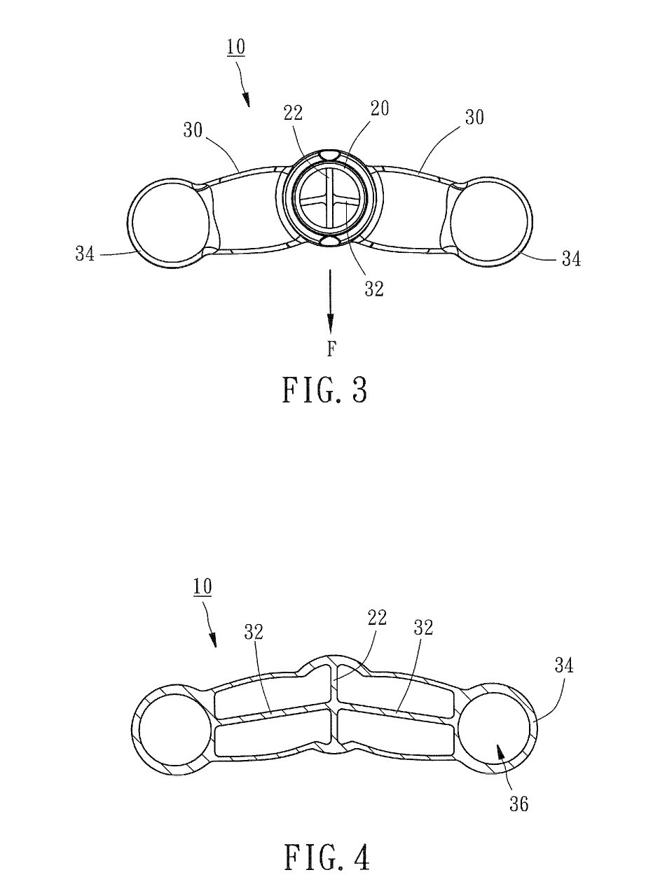

The upright tube 20 has an axial rib 22 on a lower section thereof extending along a longitudinal direction A thereof, as shown in FIG. 2, and parallel to a forward direction F of the bicycle, as shown in FIG. 3.

The branch tubes 30 extend bilaterally from a bottom end of the upright tube 20 and each have an axial rib 32 extending along a longitudinal direction B thereof and parallel to the longitudinal direction A of the upright tube 20, i.e. vertical to the horizontal, and a connecting portion 34 located at a distal end thereof and having a hole 36 for connection of a fork tube (not shown).

According to this design, the upright tube 20 can effectively enhance its structure strength to bear stress generated from the forward and backward directions of the bicycle because of the axial rib 22 parallel to the forward direction F of the bicycle. Besides, the branch tubes 30 also can enhance their structure strength to bear stress generated from the fork tubes since the axial ribs 32 are vertical to the horizontal. Thus, the upper frame 10 of the present invention has long service life and high structure strength to bear the stress from a front wheel.

The upper frame of the present invention can be made with various kinds of design on the basis of the spirit of the present invention. For example, the position and the direction of the axial rib 22 of the upright tube 20 and the axial ribs 32 of the branch tubes 30 can be provided alternatively.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An upper frame of a front fork for a bicycle, comprising:
an upright tube having an axial rib; and
two branch tubes extending bilaterally from a bottom end of said upright tube; said branch tubes each having an axial rib parallel substantially to a longitudinal direction of said upright tube, and a connecting portion located at an end of said branch tube.

2. The upper frame of front fork as claimed in claim 1, wherein said axial rib of said upright tube is substantially parallel to a forward direction of the bicycle.

3. The upper frame of front fork as claimed in claim 1, wherein said axial rib of said branch tube is substantially vertical to the horizontal.
